(19) United States
(12) Patent Application Publication
(10) Pub. No.: US 2001/0037708 A1
(43) Pub. Date: Nov. 8, 2001

(54) Cutting device and method for trimming

(76) Inventors: Wolfgang Matthes, Leipzig (DE); Lutz Richter, Schkeuditz (DE); Andreas Steinert, Leipzig (DE)

Correspondence Address: LERNER AND GREENBERG, P.A., Post Office Box 2480, Hollywood, FL, 33022-2480, US

(21) Appl. No.: 09/848,583

(22) Filed: May 3, 2001

(30) Foreign Application Priority Data
May 3, 2000 (DE) 100 21 449.5

(51) Int. Cl. B26D 1/00

(52) U.S. Cl. 83/13

(57) ABSTRACT

A cutting device for trimming margins of products includes a transport device and a first drive for driving the transport device, a stroke device for moving knives for performing the trimming of the margins, and a second drive for driving the stroke device, the first drive and the second drive being embodied as separate, mutually independent drives, and both of the drives being connected to one another via a control system; a method of trimming margins of products; and a gatherer-stitcher including the cutting device.

### BACKGROUND OF THE INVENTION

1. Field of the Invention

The invention relates to a cutting device and method for trimming margins of products, in particular, stitched or otherwise joined-together sheets of paper, the cutting device having a transport device and a first drive mechanism for driving the transport device, as well as a lifting device for moving knives for performing the margin trim, and having a second drive mechanism for driving the lifting device.

In a gatherer-stitcher, the products arriving from a stitching machine are fed via a feeding table to a transport system of a cutting device. The products taken over from this transport system are transported to front stops and aligned. The three-sided trim-off of the products is performed by the cutting device. In this regard, two different cutting principles are involved: cutting the products while stopped, and cutting the products in motion. While cutting the products in motion, as can be expected, is complicated and expensive and hence can be employed only in high-speed machines of over 16,000 T/h, cutting while stopped is employed in the lower and medium performance range. A distinction is made here between two different systems. In the first system, a belt transport system is used, which releases tension in the products immediately prior to the trimming, and moves on. In the second system, a belt transport system can be used which fixes the products, and comes to a stop therewith shortly before the cutting operation.

The three-sided trimming is performed in individual steps. The front cut is made in a first cutting station with the transport system stopped. The product is then fed by the transport system to a second cutting station. The top and bottom trim are then also performed while the transport system is stopped. Finally, the product thus trimmed on three sides is transported into the delivery.

For more-exact positional fixation of the products, U.S. Pat. No. 3,981,212 proposes a cutting device for marginal trimming of products that is capable of decoupling the drive mechanism of the knives, namely a front cutting knife and two side cutting knives, from the drive mechanism for clamping, which keep the sheets stationary during the trimming. The transport system is rigidly connected to the drive mechanism for the knife motion.

In U.S. Pat. No. 4,505,173, in this regard, a cutting device for marginal trimming of products is described wherein, in the interest of effecting a precise alignment of the products before the trimming, stops are brought up to the product on all four sides thereof.

A common problem of all such cutting devices is that because of the rigid connection between the drive mechanism for the transport system and the drive mechanism for the knife motion, the product strikes the front stops at a given speed which can cause the product to recoil. To ameliorate this effect, the transport system is set so that further travel or trailing of the transport system takes place after the impact with the front stop. In most cases, a relative movement between the product and the transport system is unavoidable. The attendant frictional contact can cause markings and scratches on the product. Additional stops are required for aligning and holding the product. They can also cause markings on the product. For transferring energy from the drive source and for converting the form of motion of the drive mechanism for the transport system, cam stepping gears are provided. It is possible, only within narrow limits, to optimize the course of motion for the purpose of reducing the impact speed of the product at the front stop. An adaptation of the transport system to the knife motion must be effected for a single sheet format, or in other words, in general, the largest sheet size, making a requisite format-dependent optimization of the transporting motion impossible.

### SUMMARY OF THE INVENTION

It is accordingly an object of the invention, therefore, to provide a cutting device with a transport system wherein the impact speed of the product at the front stop can be set as a function of the product, and the least possible trailing of the transport system is necessary.

With the foregoing and other objects in view, there is provided, in accordance with one aspect of the invention, a cutting device for trimming margins of products, comprising a transport device and a first drive for driving the transport device, a stroke device for moving knives for performing the trimming of the margins, and a second drive for driving the stroke device, the first drive and the second drive being embodied as separate, mutually independent drives, and both of the drives being connected to one another via a control system.

In accordance with another feature of the invention, the cutting device serves for trimming margins of joined-together sheets of paper.

In accordance with a further feature of the invention, the cutting device serves for trimming margins of stitched-together sheets of paper.

In accordance with an added feature of the invention, the control system includes a first and a second control unit, the first drive being linked to the first control unit, and the second drive being linked to the second control unit, and includes a connection linking the first control unit to the second control unit.

In accordance with an additional feature of the invention, the first and the second control units, respectively, enable a separate setting of one of a speed profile and of an electronic cam disk of the first drive and the second drive.

In accordance with yet another feature of the invention, the first drive is connected by the first control unit, and the second drive by the second control unit to a machine control unit.

In accordance with yet a further feature of the invention, the machine control unit has a human-machine interface.

In accordance with yet an added feature of the invention, the cutting device includes respective position transducers connected to the first and the second control units and to the first and the second drives, respectively, so that a position regulation of a respective one of the first and the second drives is performable with at least one of the first and the second control units.

In accordance with yet an additional feature of the invention, the first and the second drives are motors.

In accordance with still another feature of the invention, the drives are motors, and at least one of the control units for a respective one of the motors has a memory-programmed controller.

In accordance with another aspect of the invention, there is provided a method for trimming margins of products, which comprises the following steps: transporting the products to a first cutting station by a transport device having a first, separate drive and a control unit; making a first cut with a knife secured to a stroke station that is movable by a second, separate drive connected to a control unit; transporting the products to a second cutting station by a transport device having a first, separate drive and a control unit; and making a second cut with a knife secured to a stroke station that is movable by a second, separate drive connected to a control unit.

In accordance with a further aspect of the invention, there is provided a gatherer-stitcher having a cutting device for trimming margins of products, comprising a transport device and a first drive for driving the transport device, a stroke device for moving knives for performing the trimming of the margins, and a second drive for driving the stroke device, the first drive and the second drive being embodied as separate, mutually independent drives, and both of the drives being connected to one another via a control system.

In accordance with a concomitant feature of the invention, the products having the margins thereof trimmed by the cutting device of the gatherer-stitcher are sheets of paper joined together by stitching.

In a preferred embodiment, the cutting device has at least one controllable motor for the transport system and one controllable motor for the knife motion. Typically, these drive sources are servomotors. Both motors are connected to corresponding control units for exchanging data and/or control signals. A central controller for these individual components is advantageous as well.

The use of a cutting device according to the invention has substantial advantages. It is possible to minimize the recoil of the product, because, with the aid of an electronic controller, the courses of motion of the transport system can be set to the knife motion as a function of format. Thus, even at high speeds, the product is transported gently to the front stops, so that a higher cutting precision can be achieved. Possible deformations of the front or leading edge of the product with the attendant markings and scratches upon impact with the front stops at high speed are averted. Setting the transport system to minimal trailing is also conveniently achieved. Because of the reduction in the relative motion between the transport system and the product, the risk of marking is reduced.

It is also possible to optimize the courses of motion of the transport system and the knife motion. For example, by the realization of nonharmonic courses of motion, it is possible to move the knives quickly away from the product after the cut has been made, thus enabling rapid transport of the product onwardly. The product can be transported away immediately after the cut has been made, while the knife is still moving upwardly.

Other features which are considered as characteristic for the invention are set forth in the appended claims.

Although the invention is illustrated and described herein as embodied in a cutting device method of trimming, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, wherein:

### BRIEF DESCRIPTION OF THE DRAWINGS

FIG. 1 is a partly schematic, top, side and front perspective view of a cutting device for trimming margins of products;

FIG. 2 is a view like that of FIG. 1 slightly rotated counterclockwise, with a superstructure and side wall removed and showing drives for a transport system and for knife motion;

FIG. 3 is an enlarged fragmentary view of FIG. 2 showing the transport system in greater detail;

FIG. 4 is a partly schematic, top, side and front perspective view of a different embodiment of the drive for the transport system;

FIG. 5 is a block circuit diagram of an embodiment of a stepping drive mechanism according to the invention.

### DESCRIPTION OF THE PREFERRED EMBODIMENTS

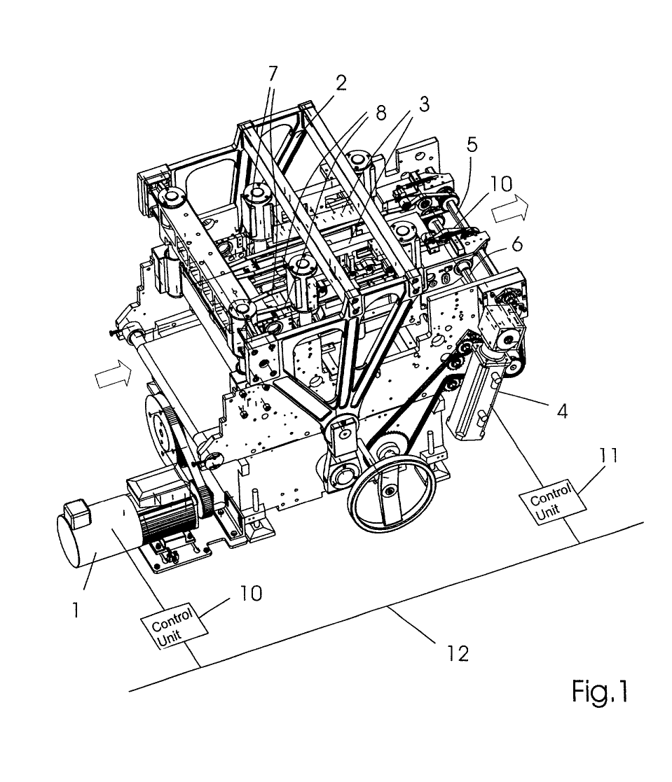

Referring now to the drawings and, first, particularly to FIG. 1 thereof, there is shown therein a representative example of a cutting device for trimming margins, which has separate drive devices. A first drive motor 1 produces the motion of a knife lifting device 2, to which knives are secured. The product travel direction is indicated by arrows. A second drive motor 4, via a first and second drive shaft 5, 6, drives belts 7 and 8 of a transport system 9. For both drive motors 1 and 4, control units 10 and 11, respectively, are provided, which can communicate with one another by a connection 12 for exchanging data and/or control signals. The connection 12 can also lead to a machine control unit.

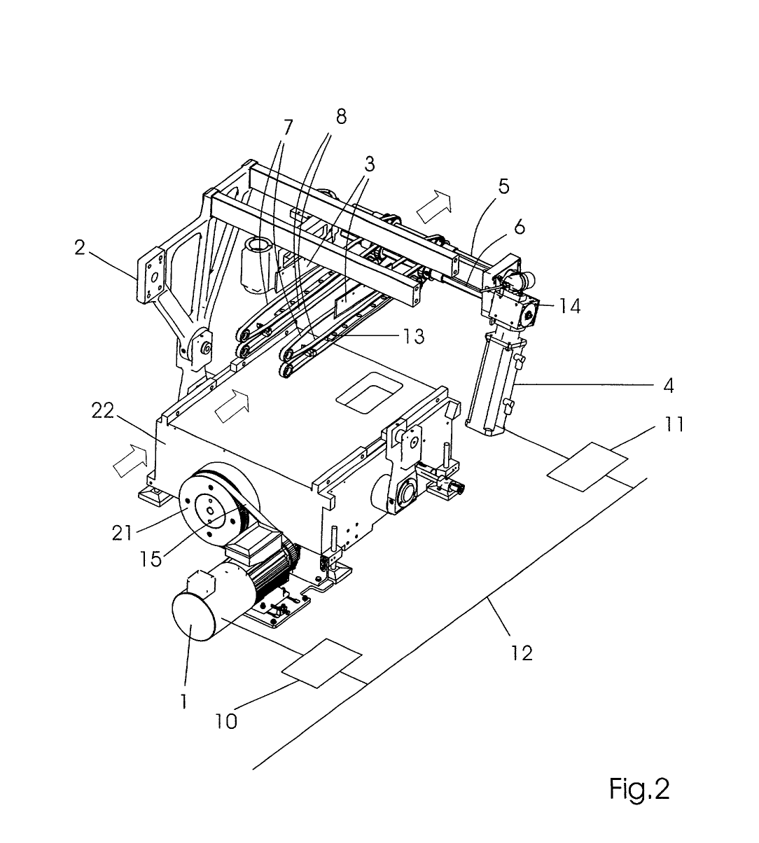

The essential elements of the drive mechanisms which achieve the two courses of motion can be seen in FIG. 2. The first drive motor 1, through the intermediary of the synchronous belt 15 of the synchronous belt pulley 21 and of the transmission 22 achieves the vertical, nonharmonic oscillatory motion of the knife lifting device 2. The knives 3 are pressed against the knife 13 during the cutting operation. The second drive motor 4, through the intermediary of a mechanical transmission 14, drives the shafts 5 and 6, so that the belts 7 and 8 of the transport system are moved. The arrows again indicate the product travel direction.

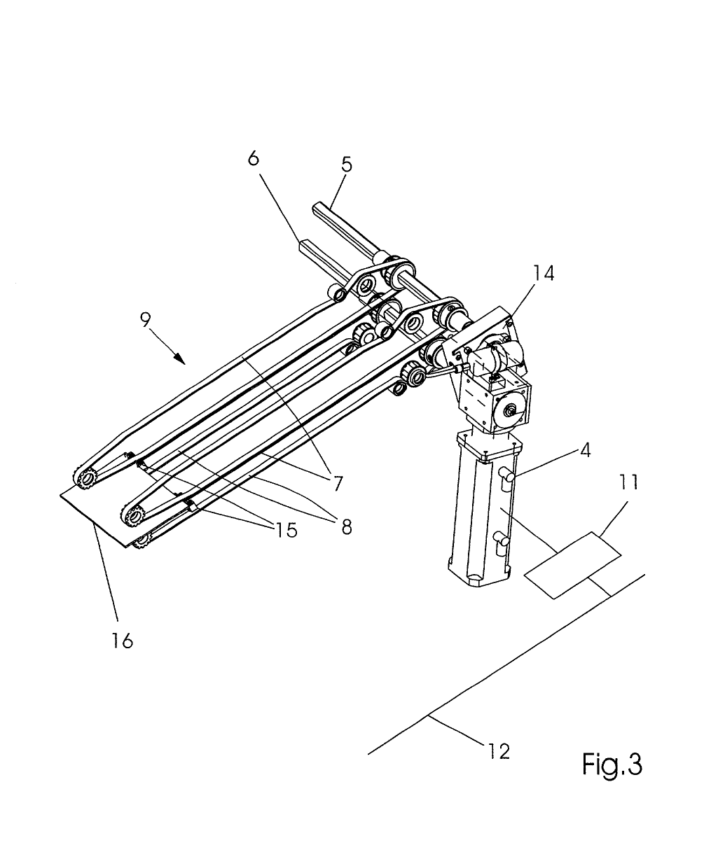

In FIG. 3, the transport system is shown by itself. Via the mechanical transmission 14, the drive motor 4 drives the drive shafts 5 and 6 so as to revolve the belts 7 and 8 of the transport system 9. The control unit 11 and the connection 12 for exchanging data and/or control signals can also be seen. The products are braked at the front stops 15, as the products arrive from a further non-illustrated transport system, from the delivery end of a stitching machine. By the electronic control provided by the control unit 11, it is possible, even at high speeds, to guide the product gently against the front stops 15.

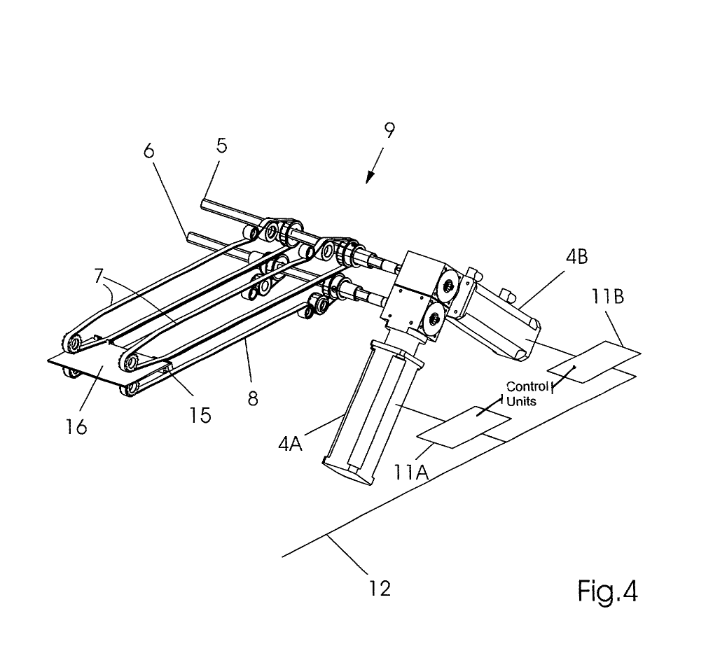

Another exemplary embodiment of the drive mechanism of the transport system is shown in FIG. 4. In this embodiment, the drive shafts 5 and 6 the belts 7 and 8, respectively, of the transport system 9 are driven by two drive motors 4A and 4B, respectively, with associated control units 11A and 11B, respectively. Coupling of the two drive motors 4A and 4B is effected via the connection 12 for exchanging data and/or control signals, which furthermore can also lead to the control unit of the knife lifting device or to the machine control unit. The product 16 transported by this system is braked at the front stops 15. In this embodiment, in addition to the described controlled motion of the conveyor belts in the interest of gently braking the product, motion of the conveyor belts relative to one another can also be achieved. In general, however, it is advantageous to coordinate the motion of the two drive mechanisms and, thus, of the two conveyor belts.

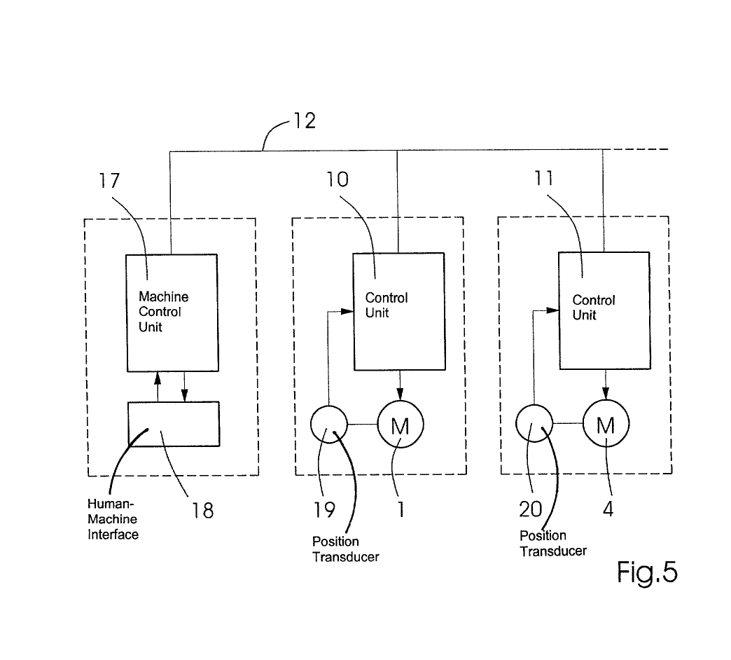

FIG. 5 shows a block circuit diagram of an embodiment of the stepping drive mechanism of the invention. The drive motor 1 for the knife motion is connected to the control unit 10 in a manner for accomplishing a regulation of the angular position of the motor shaft, or so-called position regulation. For the position regulation, a position transducer 19 is used. The drive motor 4 for the transport system 9 is also connected to the control unit 11 so that a position regulation can be effected. A position transducer 20 is used for this position regulation. The control units 10 and 11 are coupled with one another and with the machine control unit 17 via the connection 12 for exchanging data and/or control signals. The machine control unit 17 typically has a human-machine interface 18, by which settings can be made. In particular, settings are contemplated which provide the machine with information about the format and thickness of the products, the material properties of the products, and the desired speed.

For the various formats and materials to be handled, information for achieving the individual courses of motion of the transport system and of the knives is stored in memory in the electronic controller. A machine operator, through the intermediary of the human-machine interface 18, can input the relevant product parameters or select certain combinations. The machine controller then assumes the task of performing the associated courses of motion which are provided for these parameters.

We claim:

1. A cutting device for trimming margins of products, comprising a transport device and a first drive for driving the transport device, a stroke device for moving knives for performing the trimming of the margins, and a second drive for driving the stroke device, said first drive and said second drive being embodied as separate, mutually independent drives, and both of said drives being connected to one another via a control system.

2. The cutting device according to claim 1, wherein the cutting device serves for trimming margins of joined-together sheets of paper.

3. The cutting device according to claim 2, wherein the cutting device serves for trimming margins of stitched-together sheets of paper.

4. The cutting device according to claim 1, wherein said control system includes a first and a second control unit, said first drive being linked to said first control unit, and said second drive being linked to said second control unit, and includes a connection linking said first control unit to said second control unit.

5. The cutting device according to claim 4, wherein said first and said second control units, respectively, enable a separate setting of one of a speed profile and of an electronic cam disk of said first drive and said second drive.

6. The cutting device according to claim 4, wherein said first drive is connected by said first control unit and said second drive by said second control unit to a machine control unit.

7. The cutting device according to claim 6, wherein said machine control unit has a human-machine interface.

8. The cutting device according to claim 4, including respective position transducers connected to said first and said second control units and to said first and said second drives, respectively, so that a position regulation of a respective one of said first and said second drives is performable with at least one of said first and said second control units.

9. The cutting device according to claim 8, wherein said first and said second drives are motors.

10. The cutting device according to claim 4, wherein said drives are motors, and wherein at least one of said control units for a respective one of said motors has a memory-programmed controller.

11. A method for trimming margins of products, which comprises the following steps: transporting the products to a first cutting station by a transport device having a first, separate drive and a control unit; making a first cut with a knife secured to a stroke station that is movable by a second, separate drive connected to a control unit; transporting the products to a second cutting station by a transport device having a first, separate drive and a control unit; and making a second cut with a knife secured to a stroke station that is movable by a second, separate drive connected to a control unit.

12. A gatherer-stitcher having a cutting device for trimming margins of products, comprising a transport device and a first drive for driving the transport device, a stroke device for moving knives for performing the trimming of the margins, and a second drive for driving the stroke device, said first drive and said second drive being embodied as separate, mutually independent drives, and both of said drives being connected to one another via a control system.

13. The gatherer-stitcher according to claim 12, wherein the products having the margins thereof trimmed are sheets of paper joined together by stitching.
